(19) United States
(12) Patent Application Publication
(10) Pub. No.: US 2011/0118877 A1
(43) Pub. Date: May 19, 2011

(54) ROBOT SYSTEM AND METHOD AND COMPUTER-READABLE MEDIUM CONTROLLING THE SAME

(75) Inventors: Won Jun HWANG, Suwon-si (KR); Woo Sup HAN, Yongin-si (KR)

(73) Assignee: Samsung Electronics Co., Ltd., Suwon-si (KR)

(21) Appl. No.: 12/948,367

(22) Filed: Nov. 17, 2010

(30) Foreign Application Priority Data
Nov. 19, 2009 (KR) 10-2009-111930

(51) Int. Cl. B25J 13/08

(52) U.S. Cl. 700/264; 901/50

(57) ABSTRACT

A robot system rapidly performs a motion based on a gesture recognized from a user and achieves a smooth interface with the user. The system receives a gesture input by a user, and sets a position of a first gesture as a reference position, if the gesture input by the user is recognized as the first gesture. The system also judges a moving direction of a second gesture from the reference position if the gesture input by the user is recognized as the second gesture. The system recognizes a command instructing a robot to perform a motion corresponding to the judged moving direction.

### CROSS-REFERENCE TO RELATED APPLICATIONS

This application claims the benefit of Korean Patent Application No. 10-2009-0111930, filed on Nov. 19, 2009 in the Korean Intellectual Property Office, the disclosure of which is incorporated herein by reference.

### BACKGROUND

1. Field

Example embodiments relate to a robot system which rapidly performs a motion based on a gesture recognized from a user and achieves a smooth interface with the user, and a method and a computer-readable medium controlling the same.

2. Description of the Related Art

Robots are machines which move or perform motions corresponding to user commands, and include industrial robots, military robots, and robots providing services.

The user commands are provided using an input device, such as a keyboard, a joystick, or a mouse, using a specific sound, such as a voice or a clap, or using user gestures, brain waves, an electrooculogram, or an electromyogram.

If an input device, such as a keyboard, a joystick, or a mouse, is used to provide a user command to a robot, a user needs to directly operate the input device and thus suffers inconvenience, such as the need to memorize various command codes.

Further, if brain waves, an electrooculogram, or an electromyogram are used in order to provide a user command to a robot, a user needs to wear equipment to measure the brain waves, the electrooculogram, or the electromyogram, and thus suffers inconvenience. A user need to wear electrodes to measure the brain waves on a user's forehead, a pair of glasses or a helmet-type measuring instrument to measure the electrooculogram, or bipolar electrodes to measure the electromyogram on user's shoulder or neck muscles.

Moreover, if user gestures are used to provide a user command to a robot, the robot captures a user gesture and then recognizes a command corresponding to the captured user gesture, and thus a user need not directly operate an input device or wear an inconvenient instrument. Therefore, user convenience is increased, and an interface between the user and the robot is effectively achieved.

Accordingly, a novel human-robot interface, which controls movements and motions of a robot through a command giving method through gesture recognition in which commands are given to the robot using user gestures, has come into the spotlight.

However, if a user provides commands to a robot using user gestures, because there are many kinds of user gestures, many errors in extracting correct hand shape data and movement data corresponding to the user gestures are generated and the interface between the user and the robot according to a result of recognition of the user gestures is not substantially effectively achieved.

Further, the user is required to memorize robot control commands corresponding to the respective gestures, and if the user makes an incorrect gesture, which is not intuitively connected with robot control, the robot malfunctions.

Therefore, a system which easily and correctly recognizes a command corresponding to a user gesture without highly modifying the construction of a conventional robot system, has been required.

### SUMMARY

Therefore, it is one aspect of the example embodiments to provide a robot system which rapidly performs a motion based on a gesture recognized from a user and achieves a smooth interface with the user, and a method and a computer-readable medium controlling the same.

The foregoing and/or other aspects are achieved by providing a robot system including a user terminal to receive gestures input by a user, a server to recognize a first gesture, a position of which is set as a reference position, and a second gesture indicating movement of the robot, and to recognize a command corresponding to a moving direction of the second gesture from the reference position, and the robot to execute a motion corresponding to the command.

The first gesture and the second gesture of one hand of the user may indicate a moving direction of the robot, and the first gesture and the second gesture of the other hand of the user may indicate view change of the robot.

The server may judge a distance from the reference position to a position at which the second gesture of the one hand is made, and control a moving velocity of the robot based on the judged distance.

The server may judge a distance from the reference position to a position at which the second gesture of the other hand is made, and control a view changing velocity of the robot based on the judged distance.

The server may change zoom magnification of a view of the robot corresponding to the moving direction of the second gesture from the reference position.

The robot may capture an image of a vicinity of the robot, the user terminal may display the image of the vicinity of the robot, and the user may instruct the robot to perform the movement based on the image of the vicinity of the robot.

When the first gesture is re-recognized, the server may reset a position at which the re-recognized first gesture is made as the reference position.

The foregoing and/or other aspects are achieved by providing a method of controlling a robot system including receiving a gesture input by a user, setting a position of a first gesture as a reference position if the gesture input by the user is recognized as the first gesture, judging a moving direction of a second gesture from the reference position if the gesture input by the user is recognized as the second gesture, and recognizing a command instructing a robot to perform a motion corresponding to the judged moving direction.

The command, instructing the robot to perform the motion, may be transmitted to the robot, and the motion of the robot may be controlled based on the command.

An image of a vicinity of the robot may be captured and output through the robot, and the gesture may be input based on the image of the vicinity the robot.

The first gesture and the second gesture may include a first gesture and a second gesture of one hand of the user to indicate a moving direction of the robot, and a first gesture and a second gesture of the other hand of the user to indicate view change of the robot.

A distance from the reference position to a position at which the second gesture of the one hand is made may be judged, and a moving velocity of the robot may be controlled based on the judged distance.

A distance from the reference position to a position at which the second gesture of the other hand is made may be judged, and a view changing velocity of the robot may be controlled based on the judged distance.

The indication of the view change of the robot may include indicating change of zoom magnification of a view of the robot corresponding to the moving direction of the second gesture from the reference position.

When the first gesture is re-recognized, resetting a position at which the re-recognized first gesture may be made as the reference position.

The input of the gesture may include judging whether or not the user is extracted.

The foregoing and/or other aspects are achieved by providing a method, including receiving, by a robot, images of a first and second gesture provided by a user, setting, by a computer, a first reference position at which the first gesture is made by a hand of the user relative to a torso of the user, calculating, by the computer, a relative direction and a relative distance from the first reference position, to a second position of the second gesture made by the hand of the user and initiating movement of the robot, by the computer, at a velocity corresponding to the relative distance and the relative direction.

The foregoing and/or other aspects are achieved by providing at least one non-transitory computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic view of a robot system in accordance with example embodiments;

FIGS. 2 to 7 are views exemplarily illustrating a method of controlling the robot system in accordance with example embodiments; and

FIG. 8 is a flow chart of the method of controlling the robot system in accordance with example embodiments.

### DETAILED DESCRIPTION

Reference will now be made in detail to the embodiments, examples of which are illustrated in the accompanying drawings, wherein like reference numerals refer to like elements throughout.

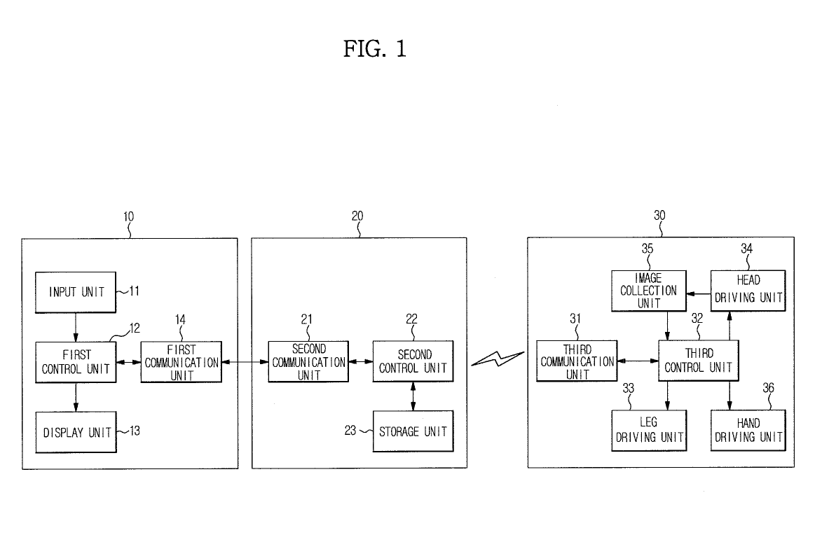

FIG. 1 is a schematic view of a robot system in accordance with example embodiments. The robot system to intuitively control motions of a robot using simple gestures may include a user terminal 10, a server 20, and a robot 30.

The user terminal 10 may output an image around or within a vicinity of the robot 30, and when a user makes a gesture based on the image around or within the vicinity the robot 30, receives the gesture and transmits the gesture to the server 20. Now, the user terminal 10 will be described in detail.

The user terminal 10 may include an input unit 11, a first control unit 12, a display unit 13, and a first communication unit 14.

The input unit 11 may receive a user command input to control a motion of the robot 30.

The input unit 11 may receive a user gesture input as the user command to control the motion of the robot 30. That is, the input unit 11 may capture a user located in a gesture recognition region, recognize a gesture, and then transmit a captured user image with the gesture to the first control unit 12.

Here, the input unit 11 which captures the user located in the gesture recognition region may be any one of a charge coupled (CCD) camera, to which a 3D depth data and a 2D pixel data are input, an infrared (IR) camera, a time-of-flight (TOF) camera, and a Z-cam.

Further, the input unit 11 may include a human detecting sensor to judge whether a user is present in the gesture recognition region. In this case, the input unit 11 may be configured such that, when the human detecting sensor judges that a user is present in the gesture recognition region, the respective units of the user terminal 10 may be operated.

The first control unit 12 may process the image transmitted from the input unit 11, and extracts a human shape using a 3D depth map, thereby judging whether a user is present in the gesture recognition region.

The first control unit 12 judges whether or not an extracted face is a face of a registered user through facial recognition. If it is judged that the extracted face is not the face of the registered user, the first control unit 12 may control the display unit 13 and the display unit 13 may display that motions of the robot 30 are uncontrollable. However, if it is judged that the extracted face is the face of the registered user, the first control unit 12 may transmit the image transmitted from the input unit 11 to the server 20. Thus, the first control unit 12 may detect a part of the image being an object of the gesture instructing the robot 30 to perform a command, and transmit an image including the detected part of the image to the server 20.

If a plurality of humans are captured, the first control unit 12 may judge that the captured humans are registered users through the facial recognition, and, if it is judged that at least two of the plural humans are the registered users, may transmit an image of a prior user to the server 20 based on the priority order of the registered users. The priority order of the registered users may be stored in advance.

During detecting the part of the image being an object of the gesture instructing the robot 30 to perform a command, the first control unit 12 may detect hands and wrists together with a face using 2D and/or 3D depth maps, and then transmit an image of a torso of the user, including the hands, being the object of the gesture instructing the robot 30 to perform the command, and the face, to the server 20.

The first control unit 12 may control the operation of the display unit 13 and cause the display unit 13 to display the image around or of a vicinity of the robot 30 received through the first communication unit 14.

The display unit 13 may output the image around or of the vicinity of the robot 30 according to instructions of the first control unit 12, and, when the robot 30 moves, may output a corresponding image around or of the vicinity the robot 30. Further, if it is judged that the human extracted through the input unit 11 is not the registered user, the display unit 13 may display that motions of the robot 30 are uncontrollable according to the instructions of the first control unit 12.

The display unit 13 may be any one of a TV, a monitor of a PC or a notebook computer, and a mobile display of a portable terminal. However, the display unit 13 is not limited to these examples.

The first communication unit 14 may transmit the image captured through the input unit 11 to a second communication unit 21 of the server 20 according to the instructions of the first control unit 12, and receive the image around or of the vicinity of the robot 30 from the second communication unit 21 of the server 20 and then transmit the image around or of the vicinity of the robot 30 to the first control unit 12.

Here, the first communication unit 14 of the user terminal 10 and the second communication unit 21 of the server 20 may be interconnected by wire or wirelessly, and thus may receive/transmit the image of the user and the image around the robot 30 through wired or wireless communication.

The server 20 may recognize the user gesture among the image transmitted from the user terminal 10, and recognize a command corresponding to the recognized gesture and then transmit the recognized command to the robot 30. Now, the server 20 will be described in detail.

The server 20 may include the second communication unit 21, a second control unit 22, and a storage unit 23.

The second communication unit 21 may execute wired or wireless communication with the first communication unit 14 of the user terminal 10, and transmit the image, received from the first communication unit 14 of the user terminal 10, to the second control unit 22.

The second communication unit 21 may execute wired or wireless communication with a third communication unit 31 of the robot 30, and transmit a command corresponding to the gesture to the third communication unit 31 of the robot 30 according to instructions of the second control unit 21, and transmit the image around or of the vicinity of the robot 30, received from the third communication unit 31 of the robot 30, to the first communication unit 14.

The second communication unit 21 may execute wireless communication with the third communication unit 31 of the robot 30, and execute remote communication between the robot 30 and the user terminal 10 and remote communication between the robot 30 and the server 20, thereby allowing the user to operate the robot 30 through remote control.

The second control unit 22 may recognize directions and shapes of user's hands using the 2D and/or 3D depth maps. That is, the second control unit 22 judges which of user's hands makes a first gesture or a second gesture. Further, the second control unit 22 may set a position at which the first gesture is made from the image of the user's torso as a reference position, calculate a relative direction and a relative distance from the set reference position to a position at which the second gesture is made, determine a moving direction, a view changing direction, a moving velocity, a view changing velocity, etc. based on the calculated direction and distance, recognize a command corresponding to the determined results, and transmit the recognized command to the robot 30.

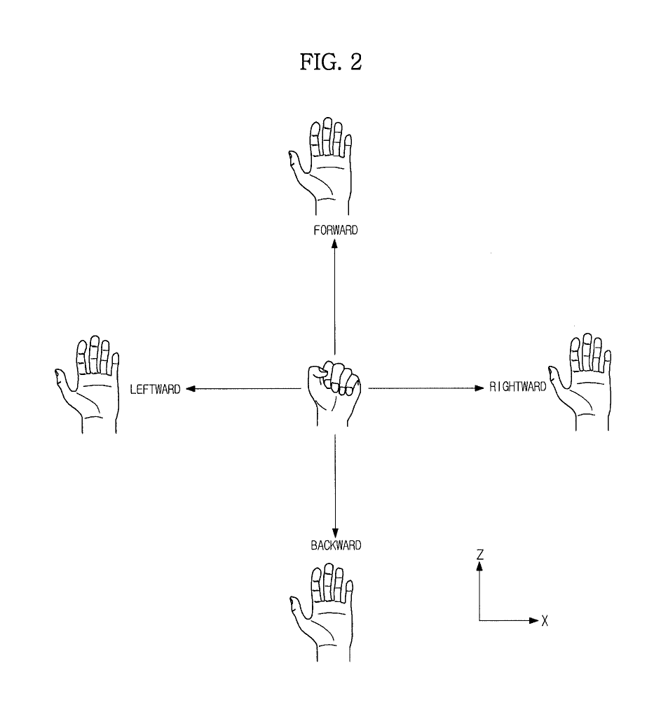

Now, with reference to FIGS. 2 to 7, a method of controlling the robot system in accordance with the example embodiments will be described in more detail.

Hereinafter, a left hand may indicate front, rear, left, and right moving directions of the robot and a right hand indicates upper, lower, left, and right view changing directions of the robot and a view zoom magnification of the robot. This will be exemplarily described.

With reference to FIG. 2, when the user makes the first gesture of the left hand (i.e., closes the left hand), a three-dimensional point of the first gesture may be set as a reference position, and then when the user makes the second gesture of the left hand (i.e., spreads out the left hand), a direction from a position at which the first gesture is made to a position at which the second gesture is made may be determined as a moving direction of the robot and then a corresponding command may be recognized. That is, a relative direction from the first gesture to the second gesture may become the moving direction of the robot, and a command corresponding to movement in this direction may be recognized and transmitted to the robot.

In more detail, assuming that, in relation with the body of the user, leftward and rightward directions may be referred to as directions of an X-axis, upward and downward directions may be referred to as directions of a Y-axis, and forward and backward directions may be referred to as directions of a Z-axis, if the direction from the position at which the first gesture of the left hand is made to the position at which the second gesture of the left hand is made is a direction of the Z-axis toward the front of the user, the direction may be recognized as a command to move the robot forward, if the direction from the position at which the first gesture of the left hand is made to the position at which the second gesture of the left hand is made is a direction of the Z-axis toward the back of the user, the direction may be recognized as a command to move the robot backward, if the direction from the position at which the first gesture of the left hand is made to the position at which the second gesture of the left hand is made is a direction of the X-axis toward the left of the user, the direction may be recognized as a command to rotate the robot left and move the robot, and if the direction from the position at which the first gesture of the left hand is made to the position at which the second gesture of the left hand is made is a direction of the X-axis toward the right of the user, the direction may be recognized as a command to rotate the robot right and move the robot.

Thereafter, when the user again makes the first gesture of the left hand, a position at which the first gesture is made is reset as a reference position, and a command to move the robot corresponding to relative direction and distance of the second gesture from the reset reference position may be recognized.

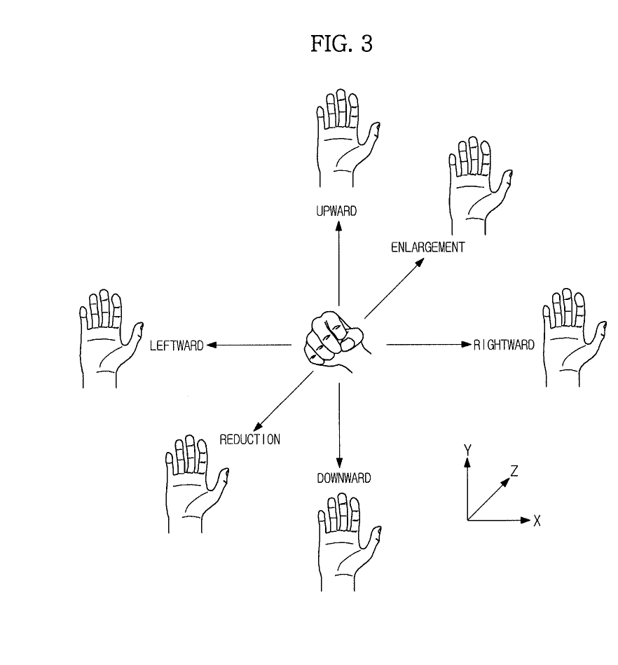

With reference to FIG. 3, a position at which the user makes the first gesture of the right hand (i.e., closes the right hand) may be set as a reference position, and then a direction from a position at which the first gesture of the right hand is made to a position at which the second gesture of the right hand (i.e., spreads out the right hand) is made may be recognized as a view changing direction of the robot. That is, a relative direction from the first gesture to the second gesture may become the view changing direction of the robot, and a command corresponding to view change in this direction may be recognized and transmitted to the robot.

In more detail, assuming that, in relation with the body of the user, leftward and rightward directions may be referred to as directions of an X-axis, upward and downward directions may be referred to as directions of a Y-axis, and forward and backward directions may be referred to as directions of a Z-axis, if the direction from the position at which the first gesture of the right hand is made to the position at which the second gesture of the right hand is made is a direction of the Z-axis toward the front of the user, the direction may be recognized as a command to enlarge a view of the robot, if the direction from the position at which the first gesture of the right hand is made to the position at which the second gesture of the right hand is made is a direction of the Z-axis toward the back of the user, the direction may be recognized as a command to reduce the view of the robot, if the direction from the position at which the first gesture of the right hand is made to the position at which the second gesture of the right hand is made is a direction of the X-axis toward the left of the user, the direction may be recognized as a command to change the view of the robot to the left, if the direction from the position at which the first gesture of the right hand is made to the position at which the second gesture of the right hand is made is a direction of the X-axis toward the right of the user, the direction may be recognized as a command to change the view of the robot to the right, if the direction from the position at which the first gesture of the right hand is made to the position at which the second gesture of the right hand is made is a direction of the Y-axis toward the upper part of the user, the direction may be recognized as a command to change the view of the robot upward, and if the direction from the position at which the first gesture of the right hand is made to the position at which the second gesture of the right hand is made is a direction of the X-axis toward the lower part of the user, the direction may be recognized as a command to change the view of the robot downward.

Thereafter, when the user again makes the first gesture of the right hand, a position at which the first gesture is made may be reset as a reference position, and a command to change the view of the robot corresponding to relative direction and distance of the second gesture from the reset reference position may be recognized.

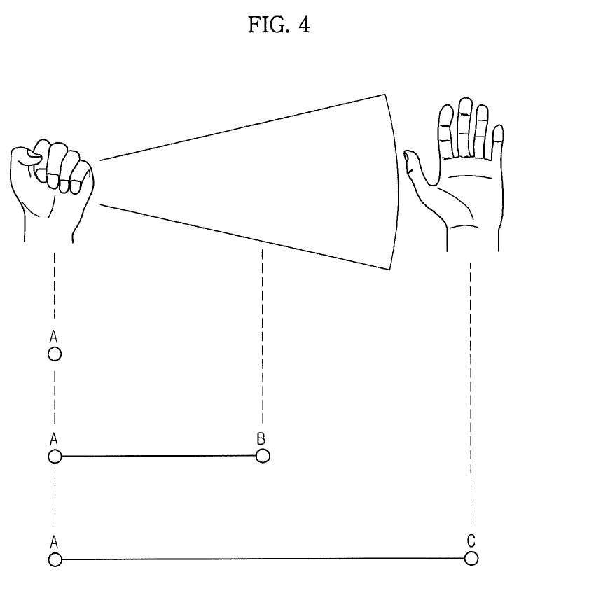

As shown in FIG. 4, the robot may move from a reference position A at which the first gesture of the user's left hand is made to a first position B or a second position C at which the second gesture of the left hand is made. Here, the robot may move at a velocity corresponding to a distance from the reference position A to the position B or C at which the second gesture of the left hand is made.

The robot may move at a first velocity corresponding to a distance from the reference position A at which the first gesture of the left hand is made to the first position B at which the second gesture of the left hand is made, and may move at a second velocity corresponding to a distance from the reference position A at which the first gesture of the left hand is made to the second position C at which the second gesture of the left hand is made. Here, since the distance from the reference position A to the second position C is greater than the distance from the reference position A to the first position B, the second velocity may be set to be higher than the first velocity.

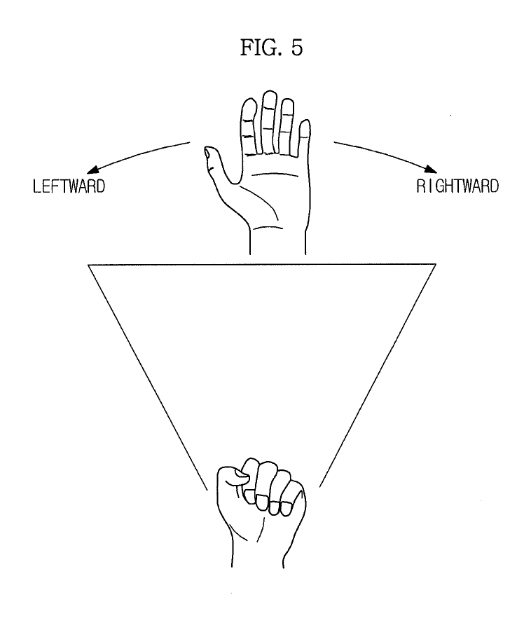

As shown in FIG. 5, if the second gesture of the user's left hand is made at a position in front of the reference position at which the first gesture of the left hand is made, a command to move the robot forward may be recognized, and if the position of the left hand in the second gesture is moved left or right by moving the left hand in the second gesture to the left or right under the condition that the robot may move forward, a command to change the moving direction of the robot left or right may be recognized.

As the left or right moving angle of the second gesture from the reference position increases, the left or right rotating angle of the robot may increase.

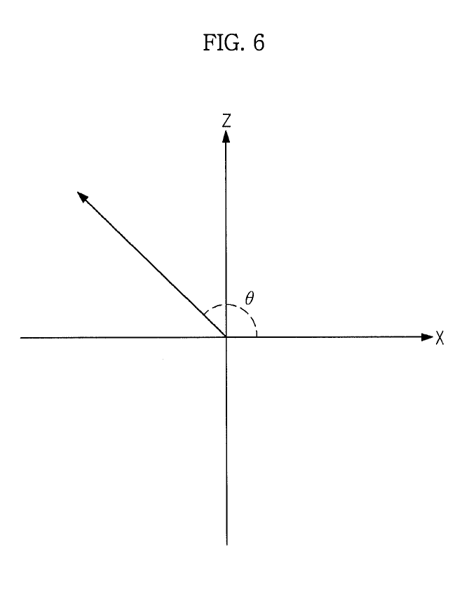

As shown in FIG. 6, the X-axis refers to the right of the user and the Z-axis refers to the front of the user. Here, the robot rotates left by an angle of

$$\frac{π}{2} - θ$$

from the front, and then moves forward.

A relative distance (a) from the reference position may be calculated by the equation a=\sqrt{(x²+z²)}. The moving velocity of the robot may be determined based on the calculated distance (a).

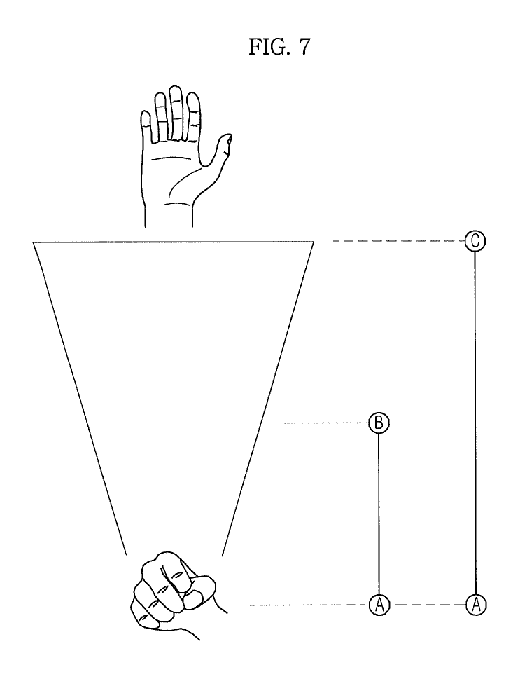

As shown in FIG. 7, the robot may move from a reference position A at which the first gesture of the user's right hand is made to a first position B or a second position C at which the second gesture of the right hand is made. The view of the robot is changed at a velocity corresponding to a distance from the reference position A to the position B or C at which the second gesture of the right hand is made.

The view of the robot may be changed at a first velocity corresponding to a distance from the reference position A at which the first gesture of the right hand is made to the first position B at which the second gesture of the right hand is made, and may be changed at a second velocity corresponding to a distance from the reference position A at which the first gesture of the right hand is made to the second position C at which the second gesture of the right hand is made. Since the distance from the reference position A to the second position C is greater than the distance from the reference position A to the first position B, the second velocity may be set to be higher than the first velocity.

The movement of the robot may be finely adjusted by controlling the movement of the robot using the relative direction of the second gesture from the first gesture, as described above. Further, the movement control velocity of the robot may be adjusted using the relative direction of the second gesture from the first gesture.

The storage unit 23 may store the first gesture and the second gesture of any one of the hands of the user as gestures indicating front, rear, left, and right moving directions of the robot, and may store the first gesture and the second gesture of the other hand as gestures indicating upper, lower, left, and right view changing directions of the robot and enlargement and reduction of the view of the robot.

Further, the storage unit 23 may store in advance moving velocities corresponding to distances from the position at which the first gesture of one hand is made to the position at which the second gesture of the hand is made, and may store in advance view changing velocities corresponding to distances from the position at which the first gesture of the other hand is made to the position at which the second gesture of the hand is made.

Further, the storage unit 23 may store in advance enlargement or reduction rates corresponding to distances from the position at which the first gesture of the other hand is made to the position at which the second gesture of the hand is made.

Moreover, the storage unit 23 may store gestures of one hand to indicate menu display and gestures of the other hand to indicate a command to interact with an object observed from a robot view.

The second control unit 22 of the server 20 may recognize a gesture of the user, and judge whether or not the recognized gesture is made by any one of both hands of the user. If the gesture is recognized as a menu display gesture made by the left hand, a menu display command is recognized and a menu is displayed, and if the gesture is recognized as an object interaction gesture made by the right hand, an object interaction command is recognized and the robot interacts with an object viewed with the robot view.

In more detail, the second control unit 22 of the server 20 may recognize the menu display command and allow a robot movement menu to be output, if the second control unit 22 recognizes a swinging gesture of the left hand, may recognize a menu upward movement command and allow the menu to move upward, if the second control unit 22 recognizes an upward movement gesture of the left hand, may recognize a menu downward movement command and allow the menu to move downward, if the second control unit 22 recognizes a downward movement gesture of the left hand, and may recognize a menu selection command and allow any one of the items of the menu to be selected, if the second control unit 22 recognizes repetition of the first and second gestures of the left hand. The second control unit 22 of the server 20 may control the user terminal 10 such that robot movement menu is displayed on the user terminal 10.

Further, the second control unit 22 of the server 20 may recognize a pointing command and transmit the point command to the robot 30 such that any one object of the captured image around the robot is set, if the second control unit 22 recognizes a pointing gesture of the right hand, may recognize a gripping command and transmit the gripping command to the robot such that the object is gripped by the robot by means of driving of a hand driving unit 36, if the second control unit 22 recognizes a gripping gesture of the right hand, may recognize a releasing command and transmit the releasing command to the robot such that the object is released by the robot by means of driving of the hand driving unit 36, if the second control unit 22 recognizes a releasing gesture of the right hand, and may recognize a throwing command and transmit the throwing command to the robot such that the robot throws the gripped object by means of driving of the hand driving unit 36, if the second control unit 22 recognizes a throwing gesture of the right hand.

Further, the server 20 may execute judgment as to whether or not a user is present in the gesture recognition region, judgment as to whether or not the user is registered, and extraction of the torso of the user through analysis of the image transmitted from the user terminal 10. The user terminal 10 transmits only the captured image to the server 20.

Otherwise, the user terminal 10 may include the server 20. In this case, the user terminal 10 may execute recognition of a gesture and recognition of a command corresponding to the recognized gesture. Here, the movement of the robot 30 may be directly controlled by the user terminal 10.

The robot 30 may drive respective driving units based on the command transmitted from the server 20 and then move the position of the robot 30 and change the view of the robot 30, and capture the image of the moved position and the changed view and then transmit the capture image to the user terminal 10. Now, the robot 30 will be described in detail.

The robot 30 may include the third communication unit 31, a third control unit 32, a leg driving unit 33, a head driving unit 34, an image collection unit 35, and the hand driving unit 36.

The third communication unit 31 may receive a command from the second communication unit 21 of the server 20, transmit the received command to the third control unit 32, and transmit an image around or in the vicinity of the robot 30 to the user terminal 10 through the second communication unit 21 of the server 20 according to instructions of the third control unit 32.

The third control unit 32 may control movements of the leg driving unit 33, the head driving unit 34, and the hand driving unit 36 according to the command transmitted through the third communication unit 31, and instruct the image collection unit 35 to transmit the collected image around or in the vicinity of the robot 30 to the third communication unit 31.

The leg driving unit 33 may cause legs of the robot 30 to move forward, backward, leftward, or rightward according to instructions of the third control unit 32, and the head driving unit 34 controls pan/tilt according to instructions of the third control unit 32 to change the view of the robot 30 upward, downward, leftward, or rightward, and controls zoom to enlarge or reduce the magnification of the view.

The image collection unit 35 may be provided on a head of the robot 30, and capture an image corresponding to a view of the robot 30 at a position at which the robot 30 is located, and transmit the captured image to the third control unit 32.

The hand driving unit 36 may cause hands of the robot 30 to perform motions, such as gripping or throwing of an object, according to instructions of the third control unit 32.

The transmission of a command from the server 20 to the robot 30 may be carried out by transmitting the command from the server 20 to a charging station (not shown) of the robot 30 and then transmitting the command from the charging station to the robot 30 connected to the charging station by wire or wirelessly.

The above robot system in which functions of both hands of a user are separated from each other and movement of the robot is controlled according to relative directions and distances from first gestures to second gestures of the respective hands may be applied to avatar control in a 3D FPS game.

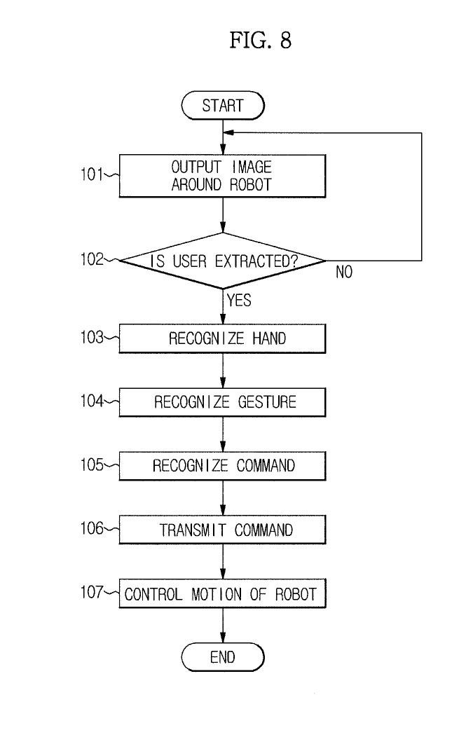

FIG. 8 is a flow chart of a method of controlling the robot system in accordance with example embodiments. Hereinafter, the method of controlling the robot system in accordance with example embodiments will be described, with reference to FIGS. 1 to 8.

An image around or of the vicinity of the robot 30 may be output through the display unit 13 of the user terminal 10 (operation 101). At this time, the image transmitted from the input unit 11 of the user terminal 10 may be analyzed, thereby judging whether or not a user is present in the gesture recognition region. The image transmitted from the input unit 11 may be processed using the 3D depth map. At this time, it may be detected whether or not a human shape is extracted (operation 102), and, if a human shape is not extracted, it is judged that no user is present in the gesture recognition region and thus the image around or of the vicinity the robot 30 may be continuously output through the display unit 13 of the user terminal, and if a human shape is extracted, it is judged that a user is present in the gesture recognition region.

Thereafter, it may be judged whether or not the extracted user is a registered user through facial recognition. If it is judged that the extracted user is not the registered user, the display unit 13 of the user terminal 10 may display that movement of the robot 30 is uncontrollable, but if it is judged that the extracted user is the registered user, the image transmitted from the input unit 11 of the user terminal 10 may be transmitted to the server 20 through wired or wireless communication.

When the image transmitted from the input unit 11 of the user terminal 10 is transmitted to the server 20, a part of the image having a gesture instructing the robot 30 to perform a command may be detected and an image of the detected part may be transmitted to the server 20.

During detecting the part of the image having the gesture instructing the robot 30 to perform the command, hands and wrists together with a face may be detected using 2D and 3D depth maps. An image of a torso of the user, including the hands, which are the object of the gesture instructing the robot 30 to perform the command, and the face, may be transmitted to the server 20.

The user makes the first or second gesture instructing the robot 30 to perform the command based on the image around the robot 30 output from the display unit 13 to the user terminal 10.

The server 20 recognizes the user gesture among the image transmitted from the user terminal 10, and transmits a command corresponding to the recognized gesture to the robot 30. Now, the above recognition process will be described in detail.

The server 20 recognizes directions and shapes of the hands using the 2D and 3D depth maps (operation 103). The server 20 may recognize which hand makes a first gesture or a second gesture (operation 104).

When the first gesture of at least one hand is made, a 3-dimensional point of the gesture may be set to a reference position, and when the second gesture of the hand may be made, relative direction and distance from the reference position to a position at which the second gesture may be made are calculated, a moving direction, a view changing direction, a moving velocity, a view changing velocity, and zoom magnification of the robot may bee determined based on the calculated direction and distance, a command corresponding to the determined results may be recognized (operation 105), and the recognized command may be transmitted to the robot 30 (operation 106).

Hereinafter, command recognition will be described in detail.

View changing and zoom magnification of the robot will be described. A left hand indicates front, rear, left, and right moving directions of the robot and a right hand indicates upper, lower, left, and right view changing directions of the robot and zoom magnification.

As shown in FIG. 2, when the user makes the first gesture of the left hand (i.e., closes the left hand), a three-dimensional point of the first gesture may be set as a reference position, and then when the user makes the second gesture of the left hand (i.e., spreads out the left hand), a direction from a position at which the first gesture may be made to a position at which the second gesture may be made is determined as a moving direction of the robot. A relative direction from the first gesture to the second gesture may become the moving direction of the robot, and a command corresponding to movement in this direction may be recognized.

As shown in FIG. 3, when the user makes the first gesture of the right hand (i.e., closes the left hand), a position at which the user makes the first gesture of the right hand (i.e., closes the right hand) may be set as a reference position, and then when the user makes the second gesture of the right hand (i.e., spreads out the left hand), a direction from a position at which the first gesture may be made to a position at which the second gesture may be made is determined as a view changing direction of the robot. A relative direction from the first gesture to the second gesture may become the view changing direction of the robot, and a command corresponding to view change in this direction may be recognized.

As shown in FIG. 4, when movement from the reference position A at which the first gesture of the user's left hand may be made to the first position B or the second position C at which the second gesture of the left hand may be made, a moving velocity command corresponding to the moving distance may be recognized. As the distance from the reference position to the position at which the second gesture of the left hand may be made increases, the moving velocity of the robot 30 may be set to be higher.

As shown in FIG. 5, if the second gesture of the user's left hand may be made at a position in front of the reference position at which the first gesture of the left hand may be made, a forward moving command may be recognized, and if the position of the left hand in the second gesture is moved left or right by moving the left hand in the second gesture to left or right so that the robot moves forward, a left or right moving direction changing command may be recognized. As the left or right moving angle of the second gesture from the reference position increases, the left or right rotating angle of the robot may increase.

As shown in FIG. 6, the X-axis refers the right of the user and the Z-axis refers the front of the user.

When the position at which the second gesture is made is moved from the reference position by an angle of θ, a rotating command corresponding to the angle of θ may be recognized. The robot may rotate left by an angle of

$$\frac{π}{2} - θ$$

from the front, and then move forward.

Further, a relative distance (a) from the reference position may be calculated by the equation a=\sqrt{(x²+z²)}. Here, the moving velocity of the robot may be determined based on the calculated distance (a), and the determined velocity may be recognized as a view changing velocity command.

As shown in FIG. 7, when the robot moves from the reference position A at which the first gesture of the user's right hand is made to the first position B or a second position C at which the second gesture of the right hand is made, the view changing velocity command may be recognized at a velocity corresponding to a distance from the reference position A to the position at which the second gesture of the right hand may be made. Here, since the distance from the reference position A to the second position C is greater than the distance from the reference position A to the first position B, the second velocity may be set to be higher than the first velocity.

The movement of the robot may be finely adjusted by controlling the movement of the robot using the relative direction of the second gesture from the first gesture, as described above. Further, the movement control velocity of the robot may be adjusted using the relative direction of the second gesture from the first gesture.

Thereafter, the robot 30 may control a motion of the robot 30 corresponding to the command transmitted from the server 20 (operation 107).

When a forward, backward, leftward, or rightward movement command is transmitted from the server 20 to the robot 30, the robot 30 may drive the leg driving unit 33 to cause the legs of the robot 30 to move forward, backward, leftward, or rightward, at a velocity corresponding to the transmitted command, and when an upward, downward, leftward, or rightward view changing command or a zoom magnification changing command is transmitted from the server 20 to the robot 30, the robot 30 may drive the head driving unit 34 to control pan/tilt at a velocity corresponding to the transmitted command and change a view or zoom magnification to execute a motion, such as enlargement or reduction of the view.

Then, the robot 30 may capture an image corresponding to this position or the view at this position, and transmit the captured image to the user terminal 10 through the server 20.

The above robot system control method in which functions of both hands of a user are separated from each other and movement of the robot is controlled according to relative directions and distances from first gestures to second gestures of the respective hands may be applied to avatar control in the 3D FPS game.

As is apparent from the above description, in accordance with one aspect of the example embodiments, when a user makes gestures in order to instruct a robot to perform commands, a position of a first gesture may be set as a reference position, relative direction and distance of a position of a second gesture may be judged based on the reference position, and a moving direction, a view changing direction, a moving velocity, a view changing velocity, and zoom magnification of the robot may be determined, thereby finely adjusting movement of the robot.

In accordance with another aspect of the example embodiments, functions of both hands of the user may be separated from each other such that commands to control the movement of the robot are provided through one hand and commands to control the view of the robot are provided through the other hand, providing an intuitive interface between the user and the robot.

Further, motions of the robot, such as the movement and the view of the robot, may be controlled through at least two simple gestures of the respective hands, thereby reducing user difficulty in memorizing various kinds of gestures and increasing accuracy in gesture recognition and further increasing accuracy in control of motions, such as the movement and the view of the robot.

Moreover, the robot system allows the user to remote-control the movement of the robot using only gestures without any separate device, improving user convenience.

The above-described embodiments may be recorded in non-transitory computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although embodiments have been shown and described, it should be appreciated by those skilled in the art that changes may be made in these embodiments without departing from the principles and spirit of the disclosure, the scope of which is defined in the claims and their equivalents.

What is claimed is:

1. A robot system, comprising:
a user terminal to receive gestures input by a user;
a server to recognize a first gesture, a position of which is set as a reference position, and a second gesture indicating movement of the robot, and to recognize a command corresponding to a moving direction of the second gesture from the reference position; and
the robot to execute a motion corresponding to the command.

2. The robot system according to claim 1, wherein:
the first gesture and the second gesture of one hand of the user indicate a moving direction of the robot; and
the first gesture and the second gesture of the other hand of the user indicate a view change of the robot.

3. The robot system according to claim 2, wherein the server judges a distance from the reference position to a position at which the second gesture of the one hand is made, and controls a moving velocity of the robot based on the judged distance.

4. The robot system according to claim 2, wherein the server judges a distance from the reference position to a position at which the second gesture of the other hand is made, and controls a view changing velocity of the robot based on the judged distance.

5. The robot system according to claim 2, wherein the server changes zoom magnification of a view of the robot corresponding to the moving direction of the second gesture from the reference position.

6. The robot system according to claim 1, wherein:
the robot captures an image of a vicinity of the robot;
the user terminal displays the image of the vicinity of the robot; and
the user instructs the robot to perform the movement based on the image of the vicinity of the robot.

7. The robot system according to claim 1, wherein, when the first gesture is re-recognized, the server resets a position at which the re-recognized first gesture is made as the reference position.

8. A method of controlling a robot system, comprising:
receiving a gesture input by a user;
setting, by a computer, a position of a first gesture as a reference position if the gesture input by the user is recognized as the first gesture
judging, by the computer, a moving direction of a second gesture from the reference position if the gesture input by the user is recognized as the second gesture; and
recognizing, by the computer, a command and instructing a robot to perform a motion corresponding to the judged moving direction.

9. The method according to claim 8, further comprising:
transmitting the command instructing the robot to perform the motion to the robot; and
controlling the motion of the robot based on the command.

10. The method according to claim 8, further comprising:
capturing and outputting an image of a vicinity of the robot by the robot; and
inputting the gesture based on the image of the vicinity of the robot.

11. The method according to claim 8, wherein the first gesture and the second gesture include:
the first gesture and the second gesture of one hand of the user to indicate a moving direction of the robot; and
the first gesture and the second gesture of the other hand of the user to indicate a view change of the robot.

12. The method according to claim 11, further comprising:
judging a distance from the reference position to a position at which the second gesture of the one hand is made; and
controlling a moving velocity of the robot based on the judged distance.

13. The method according to claim 11, further comprising:
judging a distance from the reference position to a position at which the second gesture of the other hand is made; and
controlling a view changing velocity of the robot based on the judged distance.

14. The method according to claim 11, wherein the indication of the view change of the robot includes indicating change of zoom magnification of a view of the robot corresponding to the moving direction of the second gesture from the reference position.

15. The method according to claim 8, further comprising, resetting a position at which the re-recognized first gesture is made as the reference position when the first gesture is re-recognized.

16. The method according to claim 8, wherein the input of the gesture includes judging whether the user is extracted.

17. At least one non-transitory computer readable medium comprising computer readable instructions that control at least one processor to implement a method, comprising:
receiving a gesture input by a user;
setting a position of a first gesture as a reference position if the gesture input by the user is recognized as the first gesture;
judging a moving direction of a second gesture from the reference position if the gesture input by the user is recognized as the second gesture; and
recognizing a command and instructing a robot to perform a motion corresponding to the judged moving direction.

18. A method, comprising:
receiving, by a robot, images of a first and second gesture provided by a user;
setting, by a computer, a first reference position at which the first gesture is made by a hand of the user relative to a torso of the user;
calculating, by the computer, a relative direction and a relative distance from the first reference position, to a second position of the second gesture made by the hand of the user; and
initiating movement of the robot, by the computer, at a velocity corresponding to the relative distance and the relative direction.

19. The robot system of claim 6, wherein the image includes a plurality of humans and an image of a selected prior user of the robot system is transmitted to the server based on a priority order of registered users of the robot system if it is determined by facial recognition that at least two of the humans are the registered users of the robot system.

20. The robot system of claim 1, further comprising
a second control unit to recognize the reference position and to calculate a relative direction and a relative distance from the reference position at which the second gesture is made to determine the moving direction, a view changing direction, a moving velocity, and a view changing velocity based on the relative direction and relative distance.

21. The robot system of claim 1, further comprising
a third control unit including a leg driving unit, a head driving unit, and a hand driving unit to execute the motion corresponding to the command.
